(19) United States
(12) Patent Application Publication
(10) Pub. No.: US 2014/0229208 A1
(43) Pub. Date: Aug. 14, 2014

(54) SYSTEMS AND METHODS FOR A MOBILE RELATIONSHIP MANAGER

(71) Applicant: Reinaldo Tamayo, Miami, FL (US)

(72) Inventor: Reinaldo Tamayo, Miami, FL (US)

(21) Appl. No.: 13/765,824

(22) Filed: Feb. 13, 2013

(51) Int. Cl. G06Q 10/10; G06Q 50/00

(52) U.S. Cl. CPC G06Q 10/10; G06Q 50/01
USPC 705/5

(57) ABSTRACT

In accordance with one embodiment, a portal for a mobile relationship manager providing is provided. The portal provides an enhanced user experience for social relationships, business relationships, leisure, or the like, or any combination thereof. The portal for a portal for a mobile relationship manager may include a user interface enabling the user to interact with the portal. In one embodiment of the subject matter disclosed herein, the portal may accessible using a mobile device.

### BACKGROUND OF THE INVENTION

1. Field of the Invention

Embodiments of the present invention generally relate to mobile devices, and more particularly to social and commercial mobile relationship management.

2. Description of the Related Art

The use mobile devices are becoming intensely personal. No longer are mobile devices limited to storing a list of telephone numbers, or a calendar. Increasingly they store as much, if not more, personal information about the owner, as any other devices the user owns, including, but not limited to contact information, social network relationships and contact information for friends, web browsing history, and online account information.

Increasingly, owners of mobile devices participate in online social networks. In addition, owners of mobile devices are often members of multiple online social networks, or use multiple online services. As these trends accelerate, it has become clear that the needs of owners of mobile devices are not being met. In particular, existing mobile device software typically reflects the needs of traditional cellular phones, or Personal Information Management devices, and provide little, or insufficient means to manage social network management and interaction.

Despite best efforts to date, it is clear that the needs of owners of mobile devices are not being met: the software on extant devices is poorly matched to the needs of an increasingly mobile and networked populace, especially in regard to the management of the constantly changing, complex online and offline relationships many owners of mobile devices have. Further, mobile devices seldom provide means for social interaction that model the mobile devices owners' expectations.

Wireless service providers and mobile device manufacturers have continually deliver improved device, connective, and data service to the wireless customers. However, improvement in consumers' convenience may be limited by the application installed or loaded on these devices. One area of development is social networking and relationship building including assisting consumers with managing social agendas. Another area of development is business networking and relationship building including assisting consumers with managing their business agendas. Yet another area of development is synchronization of the social networking and the business networking to streamline the customer experience further.

Geo-location of mobile devices such as mobile phones, smart phones or tablet computers conventionally is based on the use of a global positioning system (GPS). Many mobile devices have been outfitted with GPS transceivers that can transmit present location information automatically to other applications. It is possible now to determine the location of a mobile device to within a block's or even a few meters' or yards' precision. Application software that is loaded on a mobile device also can provide web browsing, game playing, and other services via the web.

Knowing the exact present location of a user or the user's communication device is useful in a host of security, military, and commercial applications. One underdeveloped area of development and commercialization, however, is in utilizing present location information to extrapolate future locations and times of arrival at those locations. If applications can be developed which accurately predict an entity's future location and time of arrival, there is likely to be savings of cost or gains in productivity.

There are numerous difficulties in accurately predicting an entity's future location and time of arrival based on their present location. Among the most complex difficulties is the fact that people are free to choose when, where, and at what rate they travel from one location to another. Also the unpredictability of traffic jams and other happenings may delay arrival at a future location beyond what is predicted. Public transportation, especially bus systems, is notoriously unable to keep schedules due to such unpredictability.

Much of the prior art in the field of location-based services and mobile commerce relates to location-sensitive communication devices for obtaining or using location-specific information. In short, many devices are built to show where a user is presently located rather than where a user will be in the future. Additionally, much prior art is focused on putting information and the power to transact in the hands of a mobile user, requiring difficult and unwieldy interaction with small, technically complex devices.

Further, another area that needs improvement is the devices that seamlessly integrate the social networking and the business networking into a single relationship manager that would use information to manage tasks, social events, business events, schedules and contact lists, and more. There is a rapidly accelerating growth in the use of mobile devices, and in particular, mobile devices that have significant processing power. Yet, there is a need to explore cloud computing for further improves the computing power of a mobile device.

### SUMMARY

In accordance with one embodiment, a portal for a mobile relationship manager providing is provided. The portal provides an enhanced user experience for social relationships, business relationships, leisure, or the like, or any combination thereof. The portal for a portal for a mobile relationship manager may include a user interface enabling the user to interact with the portal. In one embodiment of the subject matter disclosed herein, the portal may accessible using a mobile device.

In one embodiment, the portal may be configured to work only using the Short Message Service (SMS) network. The portal may communicate with one or more users via customizable audio signal, or customizable visual signal, or a customizable mechanical signal, or any combination thereof. The portal may be design to perform smart communication. For example, the portal may be configured to sense a first user, designated to receive communication, being away from first user's device or the first user's device incapable of receiving communication.

When the portal senses such an event the portal sends communication to a second user capable of conveying the communication to the first user. In one embodiment, the second user selected to convey the communication is based on at least one of geo-spatial proximity, geo-fencing, relationship between the first user and the second user, time since last contact between the first user and the second user, or the like or any combination thereof.

The portal may also include a conference module for performing conference between users. The conference module may be configured to transmit encrypted data/signal such that the data/signal is capable of avoiding digital jamming or interception. For example, the signals transmitted may be any data presently known.

In yet another embodiment, the portal includes a business module for facilitating one or more users to manage the users' business relationships, engagements, or the like, using the mobile relationship manager. The business module may further enable a business to track at least one of a users' trip history, visitor count, real-time calculation of time for one or more users to visit the business, auto-check-in, flight information comprising gate information or departure time or arrival time, customers' or users' interaction with employees or the like or any combination thereof.

In an alternate embodiment, the business module may use the tracking data collected by a business to generate at least one of a common traffic patterns, determine improvements to traffic flow, determine where to focus their available budget more efficiently, use a particular employee to serve a customer wherein the employee having received high individual score from the customer, or the like or any combination thereof.

Furthermore, the business module may also enable one or more businesses to send data, in real time, to one or more users thereby enticing one or more users to visit the business. To further enhance the user experience, the business module may provide indoor mapping of one or more businesses to one or more users allowing the one or more users to track events or locations within one or more businesses.

Additionally, the business module allows each of the businesses to provide feedback for one or more users/customers. For example, the users and/or customers may be employee, managers, executives. Moreover, the business module may further provide businesses capability to rewarding one or more users for the users' loyalty in real time or instantaneously or in advance.

The portal may also include a travel module for facilitating one or more travelers manage travel. For example, the travel may be one of ambulation, slow mobility devices such as a bicycle or wheelchair, motor transportation, rail transportation, boat or water transportation, or air transportation. The travel module also allows the traveler to engage with one or more mobile relationship manager users. For example, the traveler may interact with a taxi, vendors within the traveler's geographic location, airport authority, airline, and the like or any combination thereof. The portal may also include a media capture module for facilitating one or more users to capture media.

In an alternate embodiment of the subject matter disclosed herein the portal for a mobile relationship manager may include an advertisement module, providing users with advertisements. The advertisement module may have a coupon module to provide one or more users coupons. The coupons may be provided based on users' proximity to a business, or a given geo-location, or a given time, or depending upon the preferences of users in a group, or based upon a behavioral and/or psychological pattern of individual user or group as a whole, or the like, or any combination thereof. The coupon module may also enable one or more users to write rules to manage the performance and effect of the coupons module.

The advertisement module may show services advertisements to the users. The service advertisements may be selected based on at least one of a data captured by the portal, users' movements, users' activities inside the business and outside the business, or the like, or any combination thereof.

The portal may further include a predictive module for predicting events at least one of a behavior or a time of arrival or a choice for one or more users', users' personality, users' past choices, or the like, or any combination thereof. The predictive module may be configured to communicate with other modules or one or more peripheral devices.

Moreover, the portal may include a rule module. The rule module uses rule sets to allow a user to manage or controlling the portal. Additionally, the rule module allows creating one or more triggers allowing the users to engage with the portal. For example, each rule or rule set may be assigned a rule hierarchy value. The rule hierarchy value is used by the rule module to know the level/s within portal to which the rules apply. For example, the rule with highest hierarchy value overrules all other rules with lower hierarchy value.

For example, the user may give a high score to a business with high discount, or high score to business with better customer service, or high score to a business with favorable location or views or sceneries or sunsets, or the like, or any combination thereof.

The portal may further consist of a cloud module for cloud storage and cloud computing. The cloud module may allow each of the users to perform a multitude of sharing functions. Optionally, the portal may also contain a reporting module for generating one or more kind of reports. The reporting module may generate media, graphs, ranks, charts, data, statistics, or the like, or any combination thereof based on all the data gathered by the portal.

### BRIEF DESCRIPTION OF THE DRAWINGS

The drawings, in which like numerals represent similar parts, illustrate generally, by way of example, but not by way of limitation, various embodiments discussed in the present document.

FIG. 1 illustrates a block diagram of a Mobile Relationship Manager (MRM™) portal.

FIG. 2 is a flowchart illustrating a trip planning stage of the MRM™ portal in accordance with an embodiment.

FIG. 3 is a flowchart illustrating the MRM™ portal user traveling to the airport in accordance with an embodiment.

FIG. 4 is a flowchart illustrating the MRM™ portal assisting traveler in accordance with an embodiment.

### DETAILED DESCRIPTION

The foregoing summary, as well as the following detailed description of certain embodiments of the subject matter set forth herein, will be better understood when read in conjunction with the appended drawings. As used herein, an element or step recited in the singular and proceeded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

To the extent that the term “includes” is used in either the detailed description or the claims, such term is intended to be inclusive in a manner similar to the term “comprising” as “comprising” is interpreted when employed as a transitional word in a claim. Furthermore, the term “or” as used in either the detailed description or the claims is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B.

In the following detailed description, reference is made to the accompanying drawings which form a part hereof, and in which are shown by way of illustration specific embodiments in which the subject matter disclosed herein may be practiced. These embodiments, which are also referred to herein as “examples,” are described in sufficient detail to enable those skilled in the art to practice the subject matter disclosed herein. It is to be understood that the embodiments may be combined or that other embodiments may be utilized, and that structural, logical, and electrical variations may be made without departing from the scope of the subject matter disclosed herein. The following detailed description is, therefore, not to be taken in a limiting sense, and the scope of the subject matter disclosed herein is defined by the appended claims and their equivalents. In the description that follows, like numerals or reference designators will be used to refer to like parts or elements throughout. In this document, the terms “a” or “an” are used, as is common in patent documents, to include one or more than one. In this document, the term “or” is used to refer to a nonexclusive or, unless otherwise indicated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

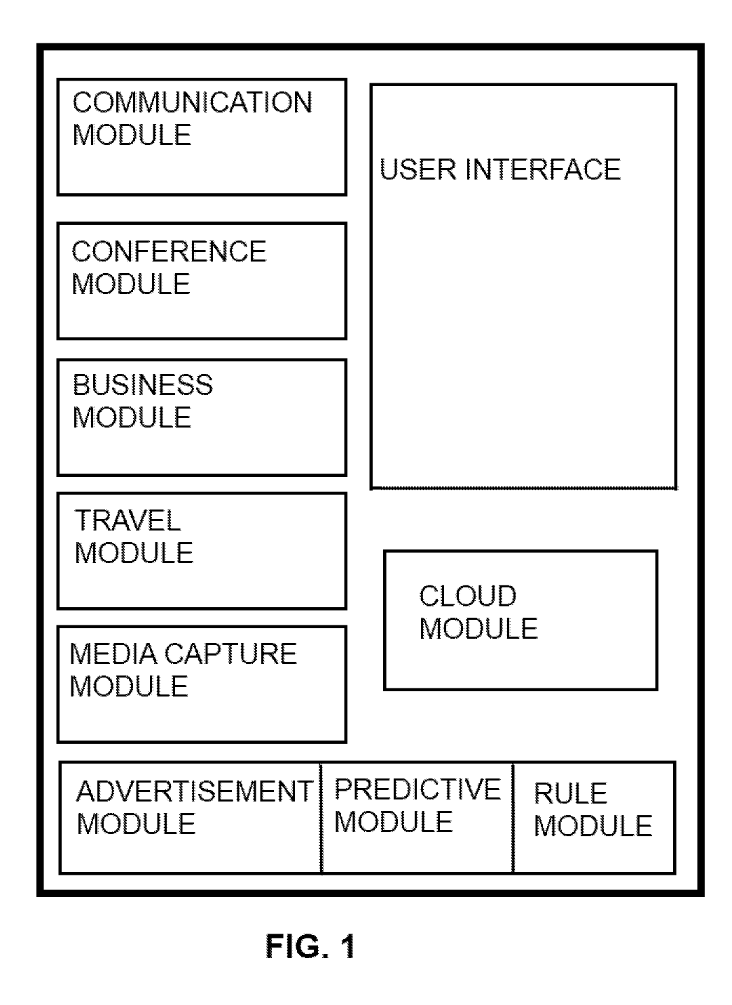

FIG. 1 illustrates a block diagram of a Mobile Relationship Manager (MRM™) portal. As can easily be gathers most of the action of the MRM™ portal is in the background and done automatically. In one embodiment of the subject matter disclosed herein the portal provides a personal assistant working at all times and managing the needs of the user and/or users. Additionally, the subject matter disclosed herein illustrates the portal used for travel, business, social interaction, or group activity. The subject matter is only an illustration and is not meant to limit the use of technology described herein to merely travel, business, social interaction, or group activity. For example, the subject matter disclosed herein may be used by non-commercial entities such as by churches, clubs, or associations.

The subject matter disclosed herein illustrates how the customer and/or third parties interact. For example, the third parties may be vendor, service provides, or manufacturers engaged as extension of the portal. Each of the users of the portal engages with the portal in a plurality of way. The plurality of ways a user may engage is by providing ratings, providing reviews, providing suggestions, and passively just by moving about and engaging in activities that can be measured and recorded by the device which is likely to include the plurality of data, or the like.

The portal provides an enhanced user experience for social relationships, business relationships, leisure, or the like, or any combination thereof. The portal for the MRM™ may include a user interface enabling the user to interact with the portal. For example, the user interface may be a touch screen based with soft keys, or may have hard keys, or may include additional audiovisual components, or mechanical components. In one embodiment of the subject matter disclosed herein, the portal may be accessible using a mobile device or other kinds of devices.

In one embodiment, the portal may be configured to work only using the Short Message Service (SMS) network. The portal may communicate with one or more users via customizable audio signal, or customizable visual signal, or a customizable mechanical signal, or any combination thereof. The portal may be design to perform smart communication. For example, the portal may be configured to sense a first user, designated to receive communication, being away from first user's device or the first user's device incapable of receiving communication.

When the portal senses such an event the portal sends communication to a second user capable of conveying the communication to the first user. In one embodiment, the second user selected to convey the communication is based on at least one of geo-spatial proximity, geo-fencing, relationship between the first user and the second user, time since last contact between the first user and the second user, or the like or any combination thereof.

In one embodiment, the MRM™ portal may automatically detect known people from the user's family or social or business or the like circle present in a close geographical proximity to the user's last known or reported location. The MRM™ portal then may send the person closest request to pass the correspondence or ask the user to turn on his phone etc.

The portal may also include a conference module for performing conference between users. The conference module may be configured to transmit encrypted audio-visual signal such that the signal is capable of avoiding digital jamming or interception.

In yet another embodiment, the portal includes a business module for facilitating one or more users to manage the users' business relationships, engagements, or the like, using the mobile relationship manager. The business module may further enable a business to track at least one of a users' trip history, visitor count, real-time calculation of time for one or more users to visit the business, auto-check-in, flight information comprising gate information or departure time or arrival time, customers' or users' interaction with employees or the like or any combination thereof.

In an alternate embodiment, the business module may use the tracking data collected by a business to generate at least one of a common traffic patterns, determine improvements to traffic flow, determine where to focus a renovation budget, use a particular employee to serve a customer wherein the employee having received high individual score from the customer, or the like or any combination thereof.

Furthermore, the business module may also enable one or more businesses to send data, in real time, to one or more users thereby enticing one or more users to visit the business. To further enhance the user experience, the business module may provide indoor mapping of one or more businesses to one or more users allowing the one or more users to track events or locations within one or more businesses.

Additionally, the business module allows each of the businesses to provide feedback for one or more users/customers. Moreover, the business module may further provide businesses capability to rewarding one or more users for the users' loyalty in real time or instantaneously or in advance.

The portal may also include a travel module for facilitating one or more travelers manage travel. The travel module also allows the traveler to engage with one or more mobile relationship manager users. For example, the traveler may interact with a taxi, vendors within the traveler's geographic location, airport authority, airline, and the like or any combination thereof.

The portal may also include a media capture module for facilitating one or more users to capture media. As used herein the term media means any one of an audio, video, image, text content, and the like or any combination thereof. For example, the media may be captured manually by the users. Optionally, the media may be captured in a semi-autonomous mode, or fully autonomous mode when enabled within the portal.

In an alternate embodiment of the subject matter disclosed herein the portal for a mobile relationship manager may include an advertisement module, providing users with advertisements. The advertisement module may have a coupon module to provide one or more users coupons. The coupons may be provided based on users' proximity to a business, or a given geo-location, or a given time, or depending upon the preferences of users in a group, or based upon a behavioral and/or psychological pattern of individual user or group as a hole, or the like, or any combination thereof. The coupon module may also enable one or more users to write rules to manage the performance and effect of the coupons module.

The advertisement module may show services advertisements to the users. The service advertisements may be selected based on at least one of a data captured by the portal, users' movements, users' activities inside the business and outside the business, or the like, or any combination thereof.

The portal may further include a predictive module for predicting events at least one of a behavior or a time of arrival or a choice for one or more users', users' personality, users' past choices, or the like, or any combination thereof. The predictive module may be configured to communicate with other modules or one or more peripheral devices.

Moreover, the portal may include a rule module. The rule module uses rule sets to allow a user to manage or controlling the portal. Additionally, the rule module allows creating one or more triggers allowing the users to engage with the portal. For example, each rule or rule set may be assigned a rule hierarchy value. The rule hierarchy value is used by the rule module to know the level/s within portal to which the rules apply. For example, the rule with highest hierarchy value overrules all other rules with lower hierarchy value.

For example, the rule with the highest hierarchy value shall be applied globally to all level within the portal. For example, the rule with the lowest hierarchy value may only be applied locally to the lowest level or sub-level within the portal. Optionally, the rules may be based on users' scores for plurality of events or attributes. For example, the user may give a high score to a business with high discount, or high score to business with better customer service, or high score to a business with favorable location or views or sceneries or sun set, or the like, or any combination thereof.

The portal may further consist of a cloud module for cloud storage and cloud computing. The cloud module may allow each of the users to performing a multitude of sharing functions. Optionally, the portal may also contain a reporting module for generating one or more kind of reports. The reporting module may generate media, graphs, ranks, charts, data, statistics, or the like, or any combination thereof based on all the data gathered by the portal.

It is to be understood that the embodiments and features that are described herein may be implemented by hardware, software, firmware or any combination thereof. Various embodiments described herein are described in the general context of methods or processes, which may be implemented in one embodiment by a computer program product, embodied in a computer-readable medium, including computer-executable instructions, such as program code, executed by computers in networked environments.

The various embodiments and/or components, for example, the modules, elements, or components and controllers therein, also may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as an optical disk drive, solid state disk drive (e.g., flash RAM), and the like. The storage device may also be other similar means for loading computer programs or other instructions into the computer or processor.

As used herein, the term “computer” or “module” may include any processor-based or microprocessor-based system including systems using microcontrollers, reduced instruction set computers (RISC), application specific integrated circuits (ASICs), field-programmable gate arrays (FPGAs), graphical processing units (CPUs), logic circuits, and any other circuit or processor capable of executing the functions described herein. The above examples are exemplary only, and are thus not intended to limit in any way the definition and/or meaning of the term “computer”.

The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments of the invention. The set of instructions may be in the form of a software program, which may form part of a tangible non-transitory computer readable medium or media. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to operator commands, or in response to results of previous processing, or in response to a request made by another processing machine.

As used herein, the terms “software”, “firmware” and “algorithm” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

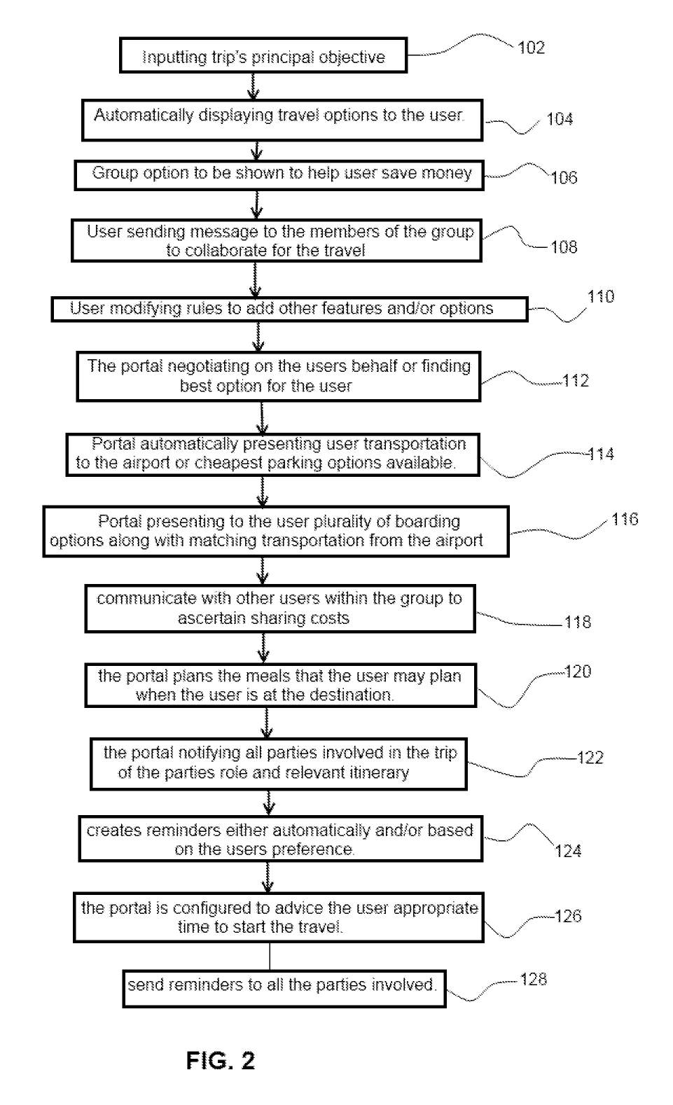

FIG. 2 is a flowchart illustrating a trip planning stage of a Mobile Relationship Manager (MRM™) portal in accordance with an embodiment. Every employee is invaluable asset when providing ideas to improving business. Generally, the employee's input is invisible to most including the management. However, the MRM™ portal allows every level of business to engage with the streamlining and improving the business. All employees provide important and valuable data towards the goal of efficiency and productivity of the business. For example a floor cleaner can uncover valuable patterns of traffic inside a business which can lead to redesign of signage and carpeting and other significant things that can improve operation, user experience, saves money and/or create new streams of income.

The flow described herein is exemplary and is not meant to describe the entire aspect of the invention. The Flow starts at 102 when user starts planning a trip. At 104, the user may create and/or editing rule that govern how the portal proceeds for the users travel plan. For example, the rules created by the user for travel may guide the portal as to options displayed and task performed for the user.

Using the user interface provided within the portal, the user enters the trip's principal objective at flow 106. The flow moves to 108 where the portal automatically displays travel options to the user. For example, the user gets started by checking out the airline hotel and car rental rates available to everyone. While showing the regular rates the user is shown any available group discounts that the user may take advantage of for travel. Moreover, the user is shown restaurant, tourist packages, transportation such as taxi, airport shuttle, etc.

In addition to the individual travel option, at 108 the portal may also show the user a group from his work, social, or other circles, or unknown portal users that may join the user in buying a group package. The user may send out request to allow the user to coordinate the travel. For example, group discount airline tickets may not be available at the time. The portal may automatically block a ticket for the users at the best rate available. The portal may continue investigating discount tickets or other cheaper options to gather tickets. The portal may also automatically block individual tickets for the group at the best rate available.

At 110 the user may modifying rules or may add rules to manage other features and/or options. The flow moves to 112 where the portal may automatically negotiate with the airlines or other travel companies to find the cheapest or best option based on the users requirements. For example, the portal may block his tickets while checking other airlines for changes in prices each hour. Additionally, the portal may check whether or not the airline has approved the group. If the group offer is cheaper and/or if the group offer is a higher preference set in the rules by the user. If the rule permits the portal will buy the group offer. At 114, the portal automatically presents user options for transportation to the airport or cheapest parking available.

At 116, the portal presents to the user one or more boarding options along with matching transportation from the airport to the boarding location. The portal may use data regarding the users past behaviors and/or social data and/or business contacts to determine the boarding options.

Furthermore, at 118 the portal may communicate with other users within the group to ascertain sharing costs for the commute to the airport, and from the airport to the boarding place of the user. Moving along, at 120 the flow involves the portal planning the meals that the user may plan when the user is at the destination. For example, the portal may assist user with finding and booking restaurants near the user boarding place which carries the user's favorite food and which takes into account recent eating habits and patterns among other data and patterns in deciding the best offers. In one instance the portal may be connected to the user's payment service. The payment services may be used by the users to pay for purchases instantly.

When all the arrangements are made for the travel, the process at 122 involves the portal notifies all parties involved in the trip itinerary role. Additionally, the portal stores all the data related to the trip on a cloud and creates reminders either automatically and/or based on the users preference. The portal is also configured to check for the odd of the trip status i.e. the trip is canceled or trip is still on. With each acknowledgement of the reminder the odds get updated higher that the trip is still on. The odds of the user make his travel plan is communicated to all the parties involved. The communication of the travel odds helps businesses and other related parties such as friends and associates as well as anyone subscribed to the trip to plan for events such as user's arrival, delay or non-arrival. For example, airlines may pre-approve or provide reliable status update to standby passengers.

The day of the travel, the portal is configured to advice the user appropriate time to start the travel. The portal may calculate the time of travel based on one or more factors. For example, the portal may decide the time of travel based on the weather conditions and/or real time traffic data. Furthermore, the portal or the MRM™ portal is configured to send reminders to all the parties involved. For example, the portal or the MRM™ portal send reminder to the taxi to pick up the user for his travel.

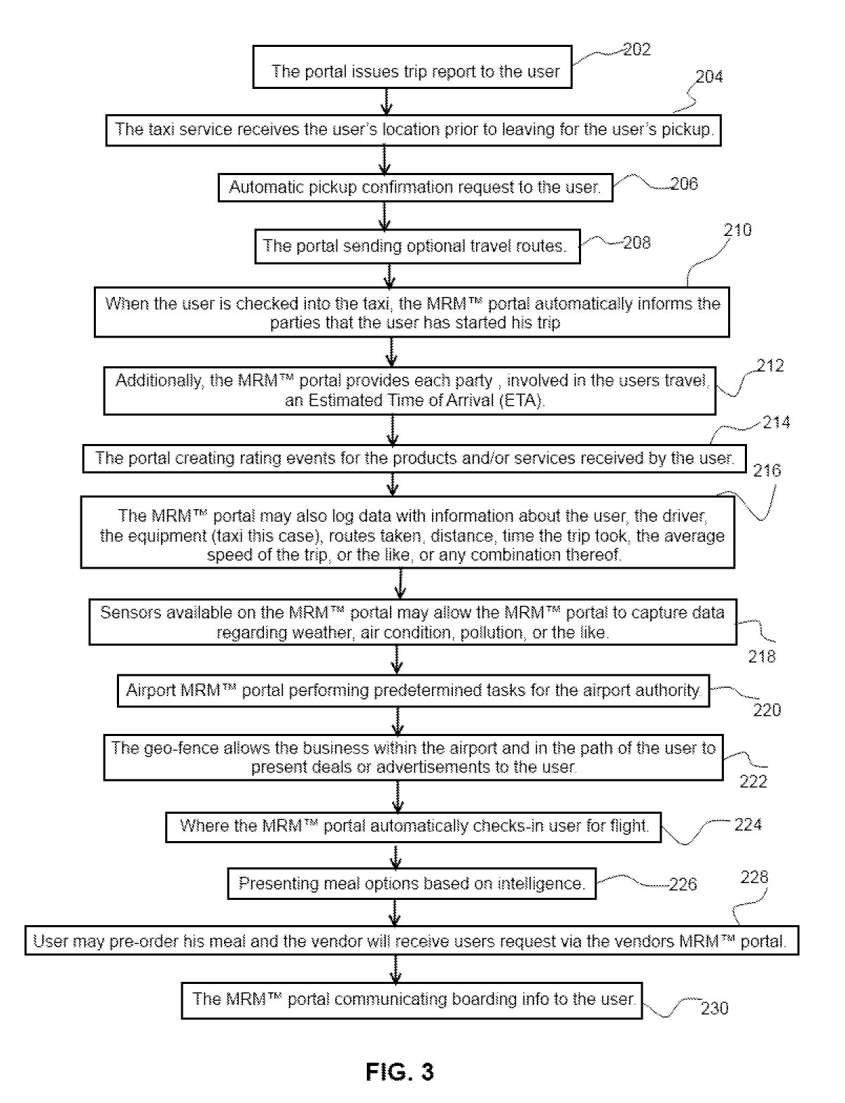

FIG. 3 is a flowchart illustrating the trip stage of a Mobile Relationship Manager (MRM™) portal in accordance with an embodiment. The flow starts at 202, where the portal issues trip report to the user. In one embodiment, the travel report is issued at least twelve hours before the trip starts. For example, the travel report may comprise prediction of traffic and/or weather conditions at both departure and arrival airport. Optionally, the travel report may comprise flight status, departure and arrival time of the flight, gate info, or the like, or any combination thereof. The MRM™ portal setup auto alarms if there are any changes in flight schedule, traffic conditions, weather conditions, or gates, etc.

When the user starts his travel day, the taxi service receives the user's location prior to leaving for the user's pickup, at 204. For example, the user may have been occupied at work and needs to leave for his travel from the user's office, instead of his home. The MRM™ portal automatically communicates the user's location to the taxi operator for pickup. The MRM™ portal used by the taxi operator recognizes a different user's location for pickup and sends an automatic confirmation request to the user.

At the same time, if the user has created rules for receiving optional travel routes, the MRM™ portal may offer suggestions. For example, the user may want to view landmarks or scenic routes on the way to or from airport. As the user engages in the start of travel, the MRM™ portal increases the probability of the trip being completed.

At 210, when the user is checked into the taxi, the MRM™ portal automatically informs the parties that the user has started his trip. For example, the airport, the airline, the hotel, friend/s, customers, anyone permitted to subscribe to the trip, any one subscribed to the trip, and all the people involved with the user will be notified. Additionally, the MRM™ portal provides each party, involved in the users travel, an Estimated Time of Arrival (ETA). For example, the MRM™ portal informs a porter, luggage rappers, businesses the user frequents at the airport, friends or acquaintances that might be at the airport at the time, etc.

As the user is dropped at the airport, the MRM™ portal creates a rating event so that the user can rate the taxi service. The Taxi's MRM™ portal receives the rating and stores the rating data for further processing. The MRM™ portal may also log data with information about the user, the driver, the equipment (taxi this case), routes taken, distance, time the trip took, the average speed of the trip, or the like, or any combination thereof.

Additionally, the MRM™ portal may capture images if some features or changes were reported by the driver or the user. For example, if there were new constructions the MRM™ portal may capture the images/video and update the routes info. Other sensors available on the MRM™ portal may allow the MRM™ portal to capture data regarding weather, air condition, pollution, or the like. All data gather by the MRM™ portal is geo tagged. The MRM™ portal may allow business to generate game scenarios where the user submitting the media generated for a contest.

The MRM™ portal used by the airport authority may automatically perform multitude of functions for the airport, at 220. The airport MRM™ portal may keep daily visitors count. The airport MRM™ portal using geo-fencing to track the user throughout the airport to determine traffic patterns. The traffic pattern may be particularly important for the airport authority to manage the airport traffic, alarms, signs, budgeting renovation money, or the like.

At 222, the geo-fence feature built into the MRM™ portal allows the business within the airport and in the path of the user to allow the business to present deals or advertisements to the user. For example, based on the behavior of the user, the baggage rappers may be notified. The user may edit travel preference in advance to request or disregard such services.

The flow move to 224, where the MRM™ portal automatically checks-in user for flight. Depending upon the time of the day and the food provided by the airline, the MRM™ portal automatically suggests the meal options for the user. The MRM™ portal shows the preferences of meals based on the users behavior, history, availability, geo-location, time to flight, or the like, or any combination thereof. In one embodiment, the MRM™ portal may use the user's eating patterns, time of day, calories user desires, calories user has burned since last meal, or the like, to recommend meals to the user.

User may pre-order his meal and the vendor will receive users request via the vendors MRM™ portal (at 230). As the user arrives at the vendors location, the user's meal may be ready, saving user valuable time. The MRM™ portal may also allow user to pay for his meal in advance. The user's movements may be tracked by the airlines and can be directly notified via the MRM™ portal if the boarding begins. In case, the user's mobile device is not receiving the signal, the MRM™ portal will automatically notify the vendors MRM™ portal and request the vendor to communicate the information to the user at 232.

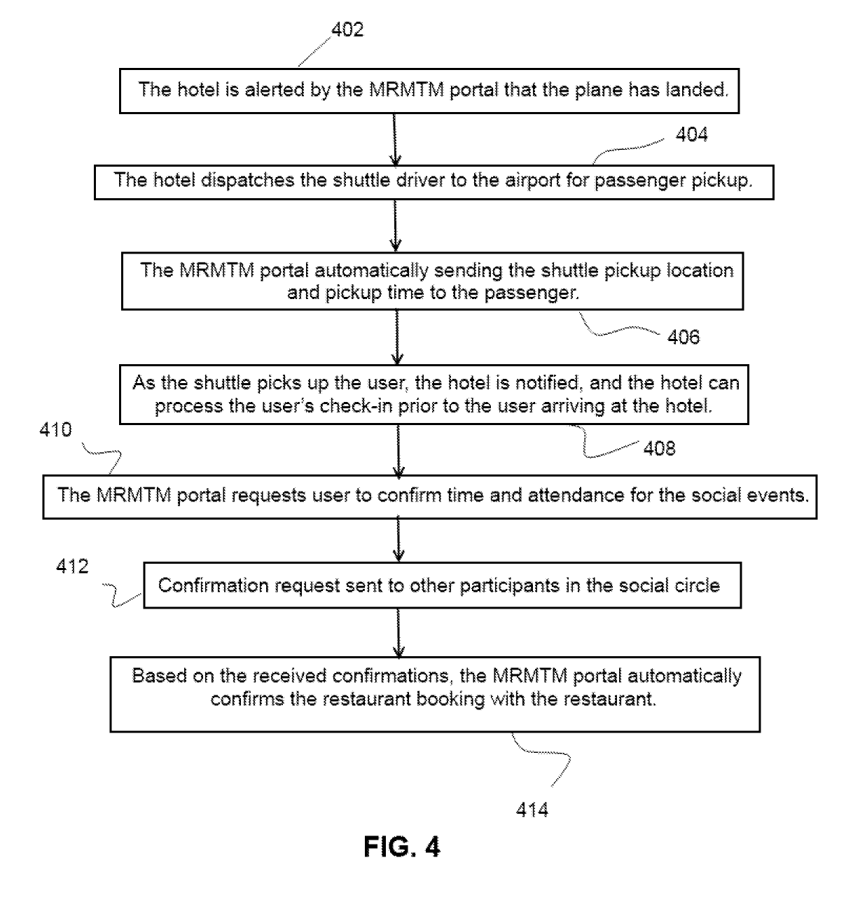

FIG. 4 is a flowchart illustrating the MRM™ portal assisting traveler in accordance with an embodiment. The flow starts at 302 when the hotel is alerted by the MRM™ portal that the plane has landed. The hotel dispatches the shuttle driver to the airport for passenger pickup at 304. The flow at 306 involves the MRM™ portal automatically sending the shuttle pickup location and pickup time to the passenger. The MRM™ portal installed on the shuttle track the user's location and displays it for the driver. The flow moves to 308, as the shuttle picks up the user, the hotel is notified, and the hotel can process the user's check-in prior to the user arriving at the hotel saving user the time required to check-in at the registration desk.

At 310 the MRM™ portal requests user to confirm time and attendance for the social events. Once confirmed by the user, the other participants in the social circle are sent a confirmation request at 312. Once confirmation is received from all parties involved, the MRM™ portal automatically confirms the restaurant booking with the restaurant (314).

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions, types of materials and coatings described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

This written description uses examples to disclose the various embodiments of the invention, including the best mode, and also to enable any person skilled in the art to practice the various embodiments of the invention, including making and using any devices or systems and performing any incorporated methods. The patentable scope of the various embodiments of the invention is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

What is claimed is:

1. A portal for a mobile relationship manager providing an enhanced user experience, wherein the portal comprises:
a user interface enabling the user to interact with the portal;
a social module for facilitating a plurality of users manage social relationships within a mobile relationship manager;
a business module for facilitating a plurality of users manage business relationships, engagements, or the like, within a mobile relationship manager;
a travel module for facilitating a plurality of travelers manage travel and engage with a plurality of users comprising at least one of a taxi, vendors within the traveler's geographic location, airport authority, airline, and the like or any combination thereof;
a media capture module for facilitating a plurality of users capture media, wherein the media capture module is operable in a manual mode, semi-autonomous mode, or fully autonomous mode; and
an advertisement module providing users with advertisements and offers.

2. The portal of claim 1 further comprises a predictive module for predicting plurality of events, wherein the event is predicted based on at least one of a behavior or a time of arrival or a choice for the plurality of users', users' personality, users' past choices, or the like, or any combination thereof, wherein the predictive module capable of communicating with other portal modules or a plurality of peripheral devices.

3. The portal of claim 1 further comprises a rule module comprising rules for controlling the portal and creating a plurality of triggers allowing the plurality of users to engage with the portal, each rule assigned a rule hierarchy value, wherein the rule applying to different portal levels within the portal based on the rule's hierarchy value.

4. The portal of claim 1 further comprises a cloud module for cloud storage and cloud computing.

5. The portal of claim 1 further comprises a reporting module generating a plurality of media, graphs, ranks, charts, data, statistics, or the like, or any combination thereof based on all the data gathered by the portal.

6. The portal of claim 1, wherein the advertisement module further comprises a coupon module to providing the plurality of users coupons based on proximity to a business, geo-location, time, users in a group, behavior of individual user or group, or the like, or any combination thereof.

7. The portal of claim 1, wherein the portal enabling the plurality of users to write rules to manage the performance and effect of the plurality of modules.

8. The portal of claim 3, wherein the rules may be based on users' scores for plurality of events or attributes.

9. The portal of claim 1, wherein the advertisement module showing services advertisements to the users, the advertisements module making decision for showing the service advertisements using at least one of a data captured by the portal, users' movements, users' activities inside the business and outside the business, or the like, or any combination thereof.

10. The portal of claim 1 is accessible using a mobile device.

11. The portal of claim 1, wherein the portal configured to sense a first user, designated to receive communication, being away from first user's device or the first user's device incapable of receiving communication, the portal sending communication to a second user capable of conveying the communication to the first user, the second user selected based on at least one of geo-spatial proximity, geo-fencing, relationship between the first user and the second user, time since last contact between the first user and the second user, or the like or any combination thereof.

12. The portal of claim 1 further comprising a conference module configured to transmit encrypted data, wherein the signal is capable of avoiding digital jamming or interception.

13. The portal of claim 1, wherein the business module further enables a business to track at least one of a users' trip history, visitor count, real-time calculation of time for the plurality of users to visit the business, auto-checkin, flight information comprising gate information or departure time or arrival time, customers' or users' interaction with employees or the like or any combination thereof.

14. The portal of claim 13, wherein the business module tracking data is further used by a business to generate at least one of a common traffic patterns, determine improvements to traffic flow, determine where to focus a renovation budget, use a particular employee to serve a customer wherein the employee having received high individual score from the customer, or the like or any combination thereof.

15. The portal of claim 1, wherein the plurality of users is enabled to schedule or reschedule an event in real time.

16. The portal of claim 1, wherein the business module enabling a plurality of businesses to send data, in real time, to the plurality of users thereby enticing the plurality of users to visit the business.

17. The portal of claim 1, wherein the business module providing indoor mapping of the plurality of businesses to the plurality of users enabling the plurality of users to track events or locations within the plurality of businesses.

18. The portal of claim 1, wherein the plurality of users are enabled to provide feedback.

19. The portal of claim 1, where in the business module enables business to provide feedback for the plurality of users.

20. The portal of claim 1, wherein the business module enables the plurality of businesses rewarding the plurality of users for the users' loyalty in real time or instantaneously or in advance.
